(19) United States
(12) Patent Application Publication
(10) Pub. No.: US 2011/0073553 A1
(43) Pub. Date: Mar. 31, 2011

(54) COSMETIC ORGANIZER DISPLAY

(76) Inventor: Laura Davis Buege, Smyrna, GA (US)

(21) Appl. No.: 12/996,279

(22) PCT Filed: Jun. 5, 2009
(86) PCT No.: PCT/US09/46378

§ 371 Date: Dec. 3, 2010

(30) Foreign Application Priority Data
Jun. 5, 2008 (US) 61/058981

(51) Int. Cl. A47F 7/00; F16M 11/22

(52) U.S. Cl. 211/59.4; 248/158; 248/415

(57) ABSTRACT

A display is disclosed that employs one or more support elements affixed to a central support or to other support elements. The support elements are configured to contain specific items, such as cosmetics. The number of support elements is user-configurable, and may be determined by a central support capacity by adjusting the size of the central support to allow for varying number of support elements. The central support may have attachment points to which support elements affix. Cover elements can be used to further secure support elements to a central support or to other support elements.

### CROSS REFERENCE TO RELATED APPLICATIONS

This application claims priority to U.S. provisional patent application No. 61/058,981, filed Jun. 5, 2008.

### FIELD OF THE INVENTION

This subject matter disclosed herein relates to a display which may be used to store and/or display cosmetics, personal hygiene items, or any other items.

### BACKGROUND

Many cosmetics users own and use several different types of cosmetics, and often several varieties of one or more types of cosmetics. For instance, many cosmetics users may own several varieties of lipsticks and mascaras. Keeping a collection of many cosmetics items organized and easily accessible can be difficult given the variety of shapes and sizes of such items, and the sheer numbers of such items that many cosmetics users acquire over time. Similar problems are encountered by any person who has several smaller items to organize and/or display.

Even when available displays and organizers may be suitable to contain items, they are often not configurable to one's needs. For example, if a person has three or four small items to display or store, the available display cases may be too large to appropriately display such a small number of items. Likewise, when a collection of items outgrows the available display case or container, such cases and containers are not able to expand easily and provide incremental growth in storage capacity. Thus, there is a need for a modular, configurable, and easy to use display system for storing and displaying multiple small items.

### SUMMARY

A display is disclosed that may include tiers of support elements affixed to one another or to a central support. The supporting elements or the central support may be affixed to a base, and a cap may be affixed to topmost support element. The support elements may be configured to rotate or to be immobile. The support elements may be designed to hold specific types of items, such as cosmetics, and have slots or other elements designed for containing such items. Support elements may affix to a central support at attachment points on the central support. Alternatively, support elements may affix to one another rather than a central support, and may be configured to affix to a variety of elements, including other support elements, caps, and bases. The display may be constructed out of any material or combination of materials.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 is a graphical representation of an exemplary, non-limiting display.

FIGS. 2a-d are graphical representations of an exemplary, non-limiting base for a display.

FIGS. 3a-c are graphical representations of an exemplary, non-limiting central support for a display.

FIGS. 4a-d are graphical representations of an exemplary, non-limiting support element for a display.

FIGS. 5a-d are graphical representations of an exemplary, non-limiting cap for a display.

FIGS. 6a-d are graphical representations of an exemplary, non-limiting cover element for a display.

FIG. 7 is a graphical representation of an exemplary, non-limiting display.

FIGS. 8a-b are graphical representations of alternative embodiments of an exemplary, non-limiting displays.

FIG. 9 is a graphical representation of an alternative embodiment of an exemplary, non-limiting display.

### DETAILED DESCRIPTION OF ILLUSTRATIVE EMBODIMENTS

The subject matter of the present disclosure is described herein in reference to several specific embodiments. For example, several embodiments of the present disclosure are described herein for use in storing and/or displaying cosmetics. However, it will be understood by those skilled in the art that various changes in form and detail may be made without departing from the scope of the present invention as set forth in the following claims. For instance, the present subject matter may be useful for storing and/or displaying other items, such as jewelry, collectibles, toys, or any other such items as may be effectively stored and/or displayed in any embodiment of the present subject matter. Furthermore, although elements of the invention may be described or claimed in the singular, the plural is contemplated unless limitation to the singular is explicitly stated.

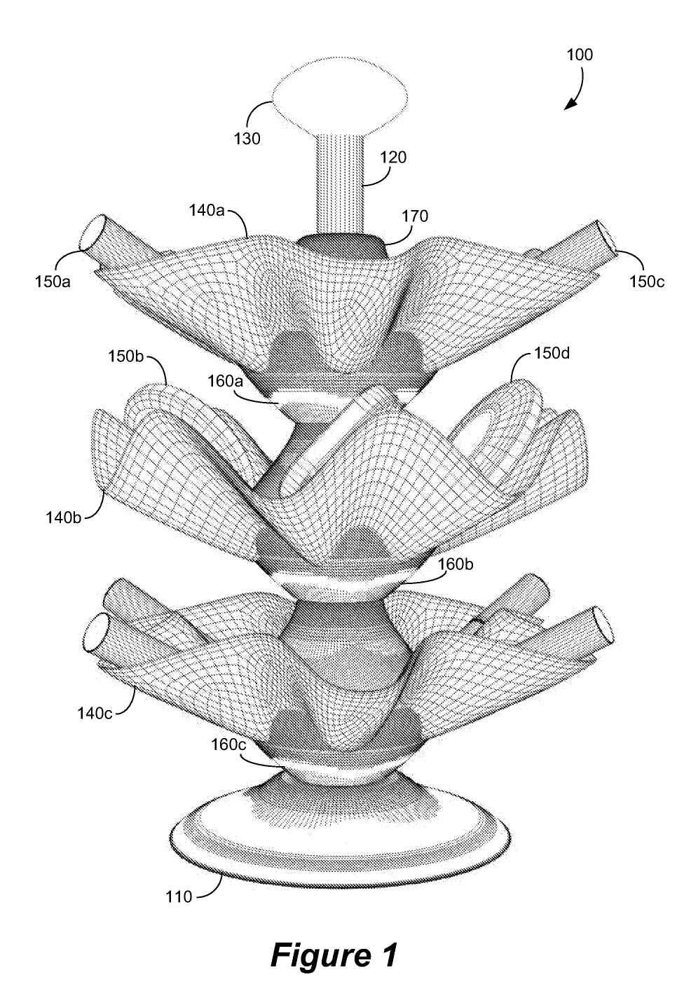

An exemplary, non-limiting embodiment of the present disclosure, display 100, is shown in FIG. 1. In this embodiment, display 100 may have a base 110 which may support the elements of display 100 and displayed items contained therein. Base 110 may be of any size and shape that enables base 110 to support the elements affixed to it. Base 110 may be constructed of any material that allows base 110 to serve as a base for display 100, including metal, wood, plastic, a composite of any materials, and any other material which furthers the purpose of the present disclosure. Alternatively, in some embodiments display 100 may have no base 110, and may be supported from above, below, or from the sides by various means known to those skilled in the art.

Affixed to base 110 may be central support 120. Base 110 and central support 120 may be a single, unified element. Alternatively, central support 120 may be affixed to base 110 using any effective means known to those skilled in the art, included one or more screws, nails, clips, rivets, hinges, or any other attachment device. In other alternatives, central support 120 may be affixed to base 110 with glue, welds, or any other adhesive means. Central support 120 may be movably affixed to base 110, such that central support 120, and elements affixed to central support 120, may rotate or move separately from base 110. In another embodiment, central support 120 may be non-movably affixed to base 110. Central support 120 may be constructed of any material that allows central support 120 to serve as a central support structure for display 100, including metal, wood, plastic, a composite of any materials, and any other material which furthers the purpose of the present disclosure. In alternative embodiments, some of which are described herein, central support 120 may be integrated into other elements, or may not be present.

Affixed atop central support 120 may be cap 130. Cap 130 may serve a purely ornamental purpose, function as a retaining element for elements affixed to central support 120, or may serve other purposes, some of which are further described herein. Cap 130 may be integrated into central support 120, and may be composed of the same or different materials as central support 120 and/or base 110.

Central support 120 may support one or more support elements such as support elements 140a-c. Support elements 140a-c may be any size and shape that facilitates their use as elements of display 100 in supporting items such as items 150a-d. For example, support elements 140a-c may be configured to receive an item shaped like a lipstick container, such as items 150a and 150c, while allowing such an item to be easily grasped by a cosmetics user. In another alternative, support elements 140a-c may be of an appropriate shape to hold an item shaped like a compact, such as items 150b and 150d, while allowing such an item to be easily grasped by a cosmetics user. In other alternatives, support elements 140a-c may be of an appropriate shape to hold items such as mascara, blush, eye shadow, lotions, powdered cosmetics, or any other item for which an effective and organized display may be desired. Support elements 140a-c may be shaped to maximize the ability of a user to grasp items supported by such elements, or shaped to maximize the view and appearance of such items, for instance when display 100 is used to display items for sale in a store.

Support elements 140a-c may be integrated into central support 120. Alternatively, support elements 140a-c may movably affixed to central support 120 such that they can rotate or move separately from central support 120 and/or from each other. For example, support element 140a may be configured to rotate without coming into contact with support element 140b or causing support element 140b to move. Support elements 140a-c may be constructed of any material that allows support elements 140a-c to serve as support elements of display 100, including metal, wood, plastic, a composite of any materials, and any other material which furthers the purpose of the present disclosure.

In one embodiment, one or more support elements such as support elements 140a-c may affixed to one or more hub elements such as hub elements 160a-c, which may be affixed to central support 120. Hub elements 160a-c may be movably affixed to central support 120 such that hub elements 160a-c and affixed support elements such as support elements 140a-c may rotate or otherwise move about central support 120. Support elements 140a-c may be integrated into hub elements 160a-c. For example, hub element 160a and support element 140a may be constructed of a single piece of material of any type. Alternatively, support elements such as support element 140a may be affixed to hub elements such as hub element 160a, either movably or non-movably. In one example, hub element 160a may be non-movably affixed to central support 120, and movable affixed to support element 140a such that support element 140a may rotate about hub element 160a while hub element 160a remains still. Such rotation may be enabled through the use of ball bearings, hinges, rotatable couplings, or any other elements. Hub elements 160a-c may be constructed of any material or combination of materials that allow hub elements 160a-c to serve as a hub element for display 100, including metal, wood, plastic, a composite of any materials, and any other material or combination of materials that further the purpose of the present disclosure.

Cover elements such as cover 170 may also be affixed to central support 120, hub elements 160a-c, and/or support elements 140a-c. Such elements may allow a modular construction of varying design while providing added support and structure to display 100. Cover 170 may be constructed to allow or enable support elements, such as support element 140a, to rotate about central support 120. Alternatively, cover 170 may be configured to retain support element 140a or cover or secure connection elements affixing support element 140a to central support 120. Like all the elements of display 100, cover 170 may be constructed of any material or combination of materials that allow cover 170 to serve as a cover element for display 100, including metal, wood, plastic, a composite of any materials, and any other material or combination of materials that further the purpose of the present disclosure.

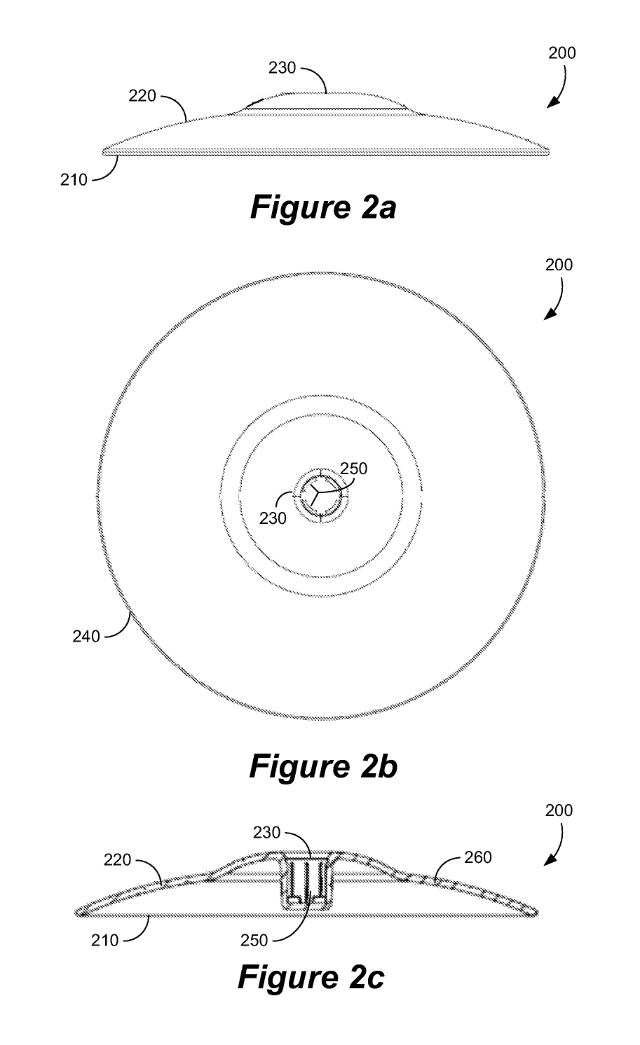

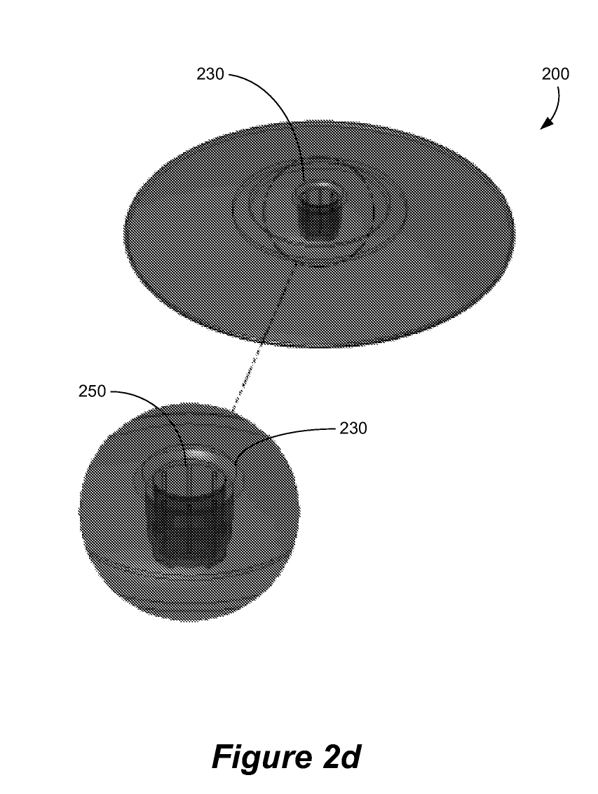

One advantage of the present disclosure is the modular construction allowing a variety of elements to be constructed which can then be assembled into various configurations and styles to create displays such as display 100. In FIGS. 2a-d, an exemplary modular base 200 is shown in more detail. In FIG. 2a, a side view of base 200 is illustrated. Base 200 may be cone-shaped or any other shape that facilitates the construction of a display. Bottom surface 210 of base 200 may be circular in shape, or may be any other shape. Top surface 220 of base 200 may be linear or variable (as shown). At center 230 of base 200, which may be the apex of a cone-shaped base, a cavity or hole may be configured for placement of a central support such as central support 120. Center 230 may be a centrally located opening slightly larger than the diameter of a central support.

In FIG. 2b, a top view of exemplary base 200 is shown. Outer perimeter 240 of base 200 may be circular, oval, or any other shape. Center 230 of base 200 may be configured as a cavity or hole in which a central support may be placed or affixed. Center 230 of base 200 may be constructed with connection elements 250 that are designed to interconnect or otherwise operate with a center support to facilitate the connection of a center support to base 200. In one embodiment, center 230 is configured to be immobile and retain a center support in place. In another embodiment, center 230 may be constructed as a modular element separate but movably affixed to base 200 that rotates or moves, allowing a center support to rotate or move when affixed to base 200 at center 230. Other variations of shapes and placements of center 230 are contemplated as within the scope of the present disclosure.

In FIG. 2c, a cross-section of exemplary base 200 is illustrated. Top surface 220 may be constructed of wall 260, which may be constructed of any appropriate material. Wall 260 may be any thickness or density, and may be constructed of a single material or a composite of materials and/or elements. Likewise, bottom surface 210 may also be constructed of any material or combination of materials and/or elements, and may be of any thickness or density. Top surface 220 and bottom surface 210 may be of the same construction or different construction. In some embodiments, bottom surface 210 may be omitted, and support for base 200 may be provided at the points where top surface 220 meets a plane or other surface upon which base 200 is set.

FIG. 2c also illustrates a cross-section of center 230, where connection elements 250 can be seen. Center 230 in this embodiment may be a cavity into which a central support element may be placed. Such a central support element may connect to or otherwise interact with connection elements 250. In alternative embodiments, center 230 may be a hole completely through base 200. Such a hole may or may not have connection elements 250 to assist in affixing base 200 to a central support. Note that in other embodiments, base 200 may be constructed of legs or other elements, and that base 200 may be of any shape and any construction that facilitates the present disclosure. All such embodiments are contemplated as within the scope of the present disclosure.

In FIG. 2d, a three-dimensional view of exemplary base 200 is shown, with an exploded view of center 230 and connection elements 250. In one embodiment, connection elements 250 may be vertical protrusions designed to interconnect to intrusions configured on a central support. In another embodiment, connection elements 250 may be threads designed to interconnect with threads on a central support. Any other connection means may be employed to affix a central support to base 200. Connection elements 250 may also be designed to interconnect with connections elements of an element other than a central support. All such embodiments are contemplated as within the scope of the present disclosure.

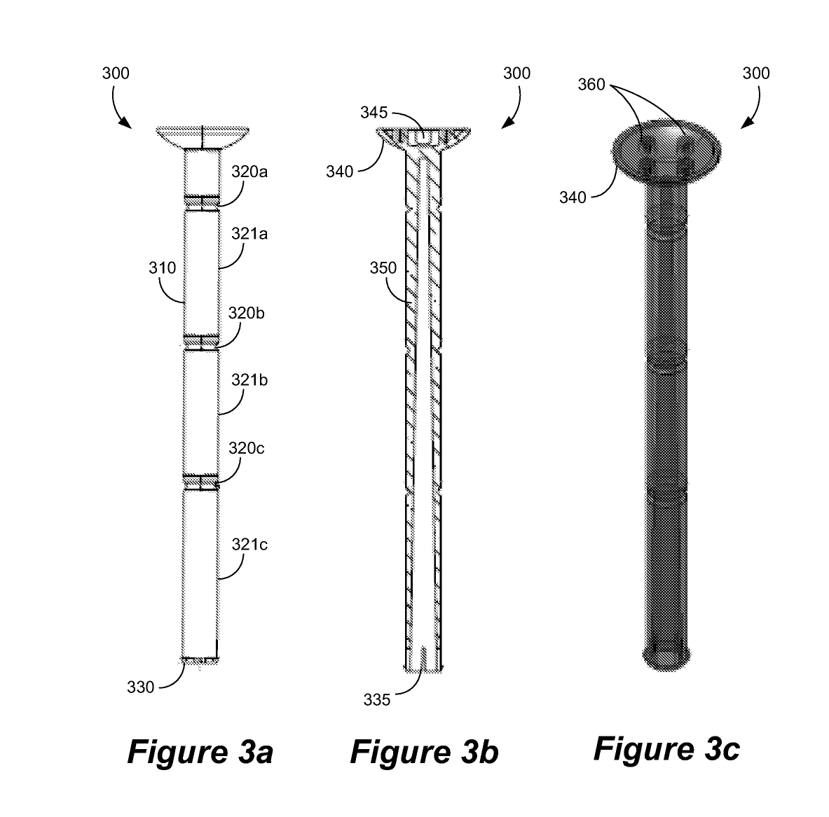

In FIGS. 3a-b, an exemplary modular central support 300 is shown in more detail. FIG. 3a is a side view of central support 300. Central support 300 may constructed of a elongated columnar element 310, which may be of any shape and constructed of any material and number of elements, or any combination of materials and/or elements. Alternatively, element 310 may be a shape that is not columnar. Central support 300 may be constructed of a single element, where columnar element 310, and top element 340 are a single piece. Alternatively, central support 300 may be assembled from various elements. For example, sections 321a-c may be separate elements that may be affixed to one another through various means, including threaded connections and interlocking elements. Top element 340 may also connect to one or more of sections 321a-c through various means, including threaded connections and interlocking elements. Each of sections 321a-c may provide or enable the support of one or more support, hub and/or cover elements such as those described herein.

In one embodiment, a varying number of sections 321a-c may be used to construct a central element of various sizes. For example, in one embodiment each of sections 321a-c can provide support for one support element. If a user wishes to have a display that is configured with two support elements, the user may construct a central support from two sections such as sections 321a-c. Any other number of sections may used to create any display configuration.

In some embodiments, some of sections 321a-c may have a particular construction based on their function. For example, section 321c may be constructed to be the bottom section of a display, and may have connection elements 330 that may be designed to interconnect or affix to a base as described herein. Likewise, top element 340 may be constructed to be the top section of a display, and maybe designed to affix to the topmost of sections 321a-c, and/or affix to a cap as described herein. Alternatively, each of sections 321a-c and/or top element 340 may be designed to serve as any of a topmost, bottommost, and/or intermediate section, and may be designed to attached or affix to other sections, a base, and/or a cap. All such embodiments are contemplated as within the scope of the present disclosure.

Element 310 may have notches 320a-c that may facilitate the connection of other elements, such as hub, cap, or support elements such as those described herein. Notches 320a-c may provide a fixture point for hub, cap, and/or support elements. Notches 320a-c may be protrusions rather than notches, or may be of any other construction that facilitates the attachment of other elements. In some embodiments, notches 320a-c may be created at the attachment point of sections such as sections 321a-c and top element 340. Any other form or construction of notches or other elements designed to interact with support, hub, or cover elements is contemplated as within the scope of the present disclosure.

FIG. 3b illustrates a cross-section of exemplary central support 300. Central support 300 may be constructed with walls 350, which may be of any density and thickness, and may be uniformly constructed or constructed of varying thickness and/or density. Within top element 340 may be cavity 345 that may be a cavity or hole in the top most section of central support 300. Cavity 345 may be constructed with attachment elements that facilitate the affixation or attachment of a cap element. It is contemplated that any other form of attachment element may be constructed into top element 340 or any other section of central support 300 that may facilitate the attachment or affixation of a cap is within the scope of the present disclosure.

Central support 300 may also be constructed with base attachment elements 335 that may facilitate the attachment of central support 300 to any base including, but not limited to, those described herein. Base attachment elements 335 may be constructed to interconnect or affix to a base, or may be constructed to facilitate the movement of central support 300 within a base, or the movement of a base about central support 300. Any embodiment of base attachment elements is contemplated.

FIG. 3c illustrates a three dimensional view of exemplary central support 300. Within top 340, and/or about or proximate to cavity 345, cap attachment elements 360 may be configured. Cap attachment elements 360 may be constructed to interconnect or otherwise facilitate the attachment or affixation of a cap to the topmost element of central support 300. Any form of attachment is contemplated as within the scope of the present disclosure.

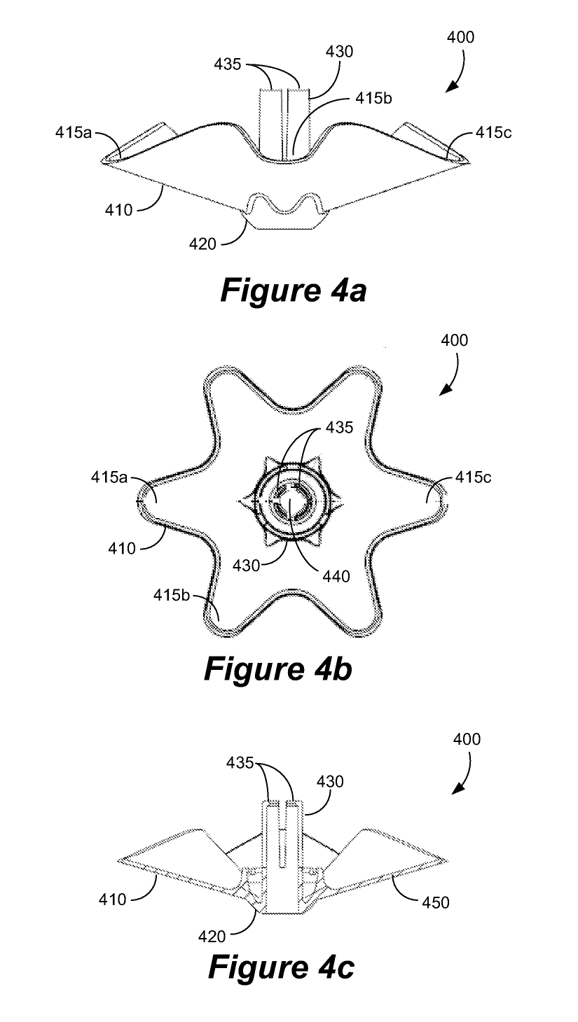

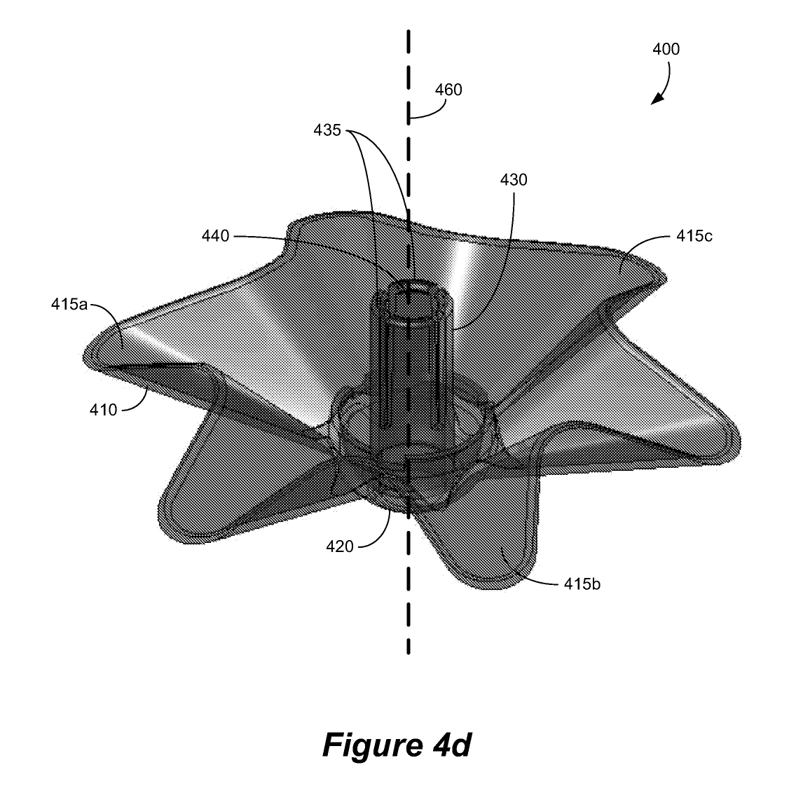

In FIGS. 4a-d, an exemplary modular support element 400 is shown in more detail. FIG. 4a is a side view of support element 400. Support element 400 may have one or more support sections 410. Support section 410 may be constructed of a single element designed to support or otherwise contain one or more items such as cosmetics items. For example, in one embodiment, support section 410 is a single element molded from a single piece of material, such as plastic or metal, to create slots 415a-c that are appropriately sized to hold lipsticks, compacts, etc. Alternatively, support section 410 may be constructed of more than one element and/or configures to hold items of any size or shape.

Support element 400 may include hub 420 that may be a separate element that is attached to one or more other elements of support element 400. Alternatively, hub 420 may be integrated into an element of support element 400, such as support section 410 and constructed out of the same piece of material as another section of support element 400. Hub 420 may facilitate the interconnection of support element 400 with a central support. Hub 420 may allow support element 400 to rotate or move about a central support, or hub 420 may non-movably affix support element 400 to a central support. Hub 420 may include connection elements designed to affix to attachment points on a central support, such as notches 320a-c described in regard to FIGS. 3a-d.

Support element 400 may also be constructed with central connection element 430. Central connection element may be a separate element that is attached to one or more other elements of support element 400. Alternatively, central connection element 430 may be integrated into an element of support element 400, such as support section 410 and constructed out of the same piece of material as another section of support element 400. In one embodiment, central connection element 430 may be constructed with connection elements 435. Connection elements 435 may be constructed to attach, affix, or otherwise facilitate the connection of support element 400 to a central support element. For example, in one embodiment, connection elements 435 may be pliable and may snap into attachment points on a central support, such as notches 320a-c described in regard to FIGS. 3a-d. Central connection element 430 and/or connection elements 435 may also have connection points and/or connection elements for affixing other elements, such as a cover element. Such a cover element may be configured to secure connection elements 435 to a central support, provide aesthetic improvements to a display, or perform other functions. Any other form of connection means, located anywhere on support element 400, is contemplated as within the scope of the present disclosure.

FIG. 4b is a top view of support element 400. In one embodiment, as seen in FIG. 4b, support section 410 is molded to create recessions or slots 415a-c that are capable of containing or supporting items. Slots 415a-c may be of any size, shape, depth, or orientation, and may be constructed specifically for particular items or for a wide variety of items. Also illustrated in FIG. 4b is central connection element 430, and the connection elements 435. Support element 400 may have a hole or cavity 440 that may be a centrally located opening slightly larger than the diameter of a central support through which a central support may be inserted. When inserted through hole 440, connection elements 435 may affix to the central support as described herein, including by snapping into or otherwise entering notches or other connection points as described in regard to central support 300 in FIGS. 3a-d. Alternatively, connection elements 435 may be configured to attach to other support elements, including to hubs and/or central connection elements of other support elements, or to a base or cap of a display. It is contemplated that any means of attachment may be used.

FIG. 4c is a cross-sectional view of support element 400. Support section 410 may be constructed with wall 450, which may be any suitable material and may be any thickness or density of material. The thickness and density of wall 450 may be consistent throughout support section 410, or it may be variable. Hub 420 may be integrated into support section 410, and may also be constructed with wall 450. Similarly, central connection element 430 and/or connection elements 435 may be constructed of the same material as wall 450. In some embodiments, any of the elements of support element 400 may be constructed of a combination of two or more materials and/or elements. Any such construction is contemplated as within the scope of the present disclosure.

FIG. 4d is a three-dimensional view of support element 400. In one embodiment, a central support may be inserted through hole 420, affixing hub 420, support element 410, and central connection element 430 to the central support such that each of these elements is oriented about axis 460. Connection elements 435 may affix to notches or other connection points on the central support. Items may be placed in slots 415a-c for display and access by users. Support element 400 may be rotatable about axis 460 once affixed to a central support, or it may be non-movably affixed to a central support. In some embodiments, rather than a molded circular shape such as that shown in Figured 4a-d, support element 400 may be constructed of branch elements designed to hold or support particular items. Any other configuration or construction of a support elements is contemplated as within the scope of the present disclosure.

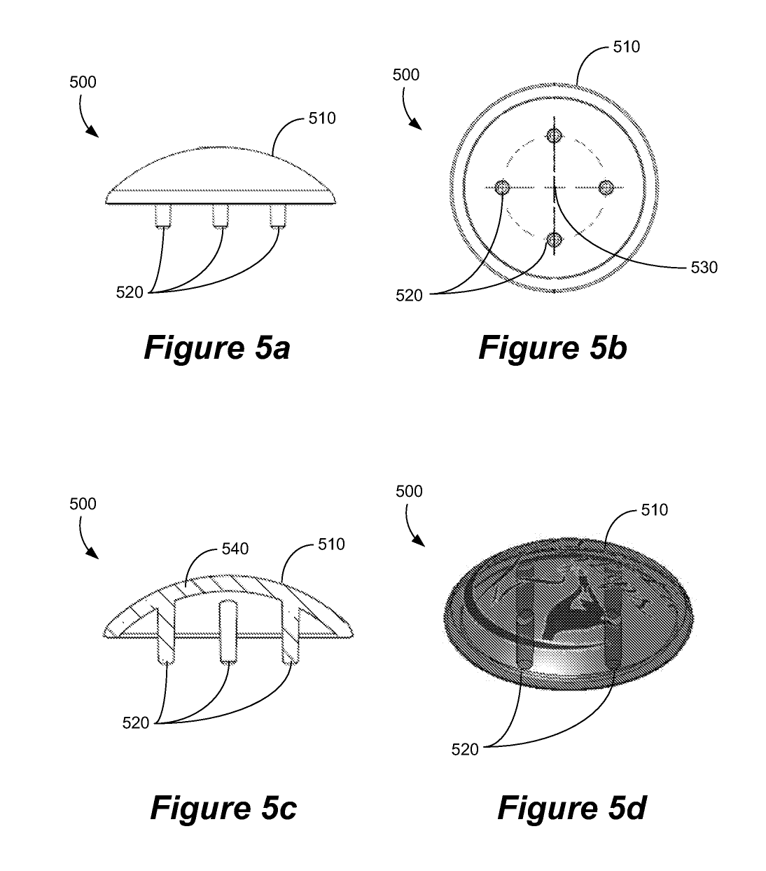

FIGS. 5a-d illustrate an exemplary cap 500 that may be an element of a display. FIG. 5a shows a side view of cap 500. Cap 500 may have a top section 510 and connection elements 520. Top section 510 and connection elements 520 may constructed from a single piece of material, or from separate elements affixed to one another. Top section 510 may provide an area for decorative display or brand markings. Connection elements 520 may affix or otherwise attach to a topmost section of a display, such as the topmost section of a central support. Alternatively, connection elements 520 may affix to a support element that is located at the topmost portion of a display. Cap 500 may be integrated into a central support or a support element, or any other element of a display. Cap 500 may be spherical, hemispherical, cubic, or any other shape, and may be constructed of any material or combination of materials, and any number of individual elements. All such configurations are contemplated as within the scope of the present disclosure.

FIG. 5b illustrates a bottom view of cap 500. Connection elements 520 may be arranged about center 530 of cap 500. It is contemplated that any number of connection elements may be employed.

FIG. 5c illustrates a cross-sectional view of cap 500. Cap 500 may include walls 540 that may be constructed of any material or combination of materials. Connection elements 520 may be integrated into top section 510. FIG. 5d illustrates a three-dimensional view of cap 500.

Cap 500 may also provide additional functions. Cap 500 may be constructed to provide support for one or more items. For example, cap 500 may be constructed such that it can support or contain a lipstick, other cosmetic item, or any other item. Cap 500 may also be constructed so that is it an ornamental element of the display. Cap 500 may also serve as a means to secure support elements to as display. For example, cap 500 may affix to a central support element and be of such a size and shape that support elements cannot be removed from the central support without removal of cap 500. Cap 500 may be affixed to a central support using any means known to those skilled in the art, including threading, screws, adhesives, welding, clips, friction, or any other effective means.

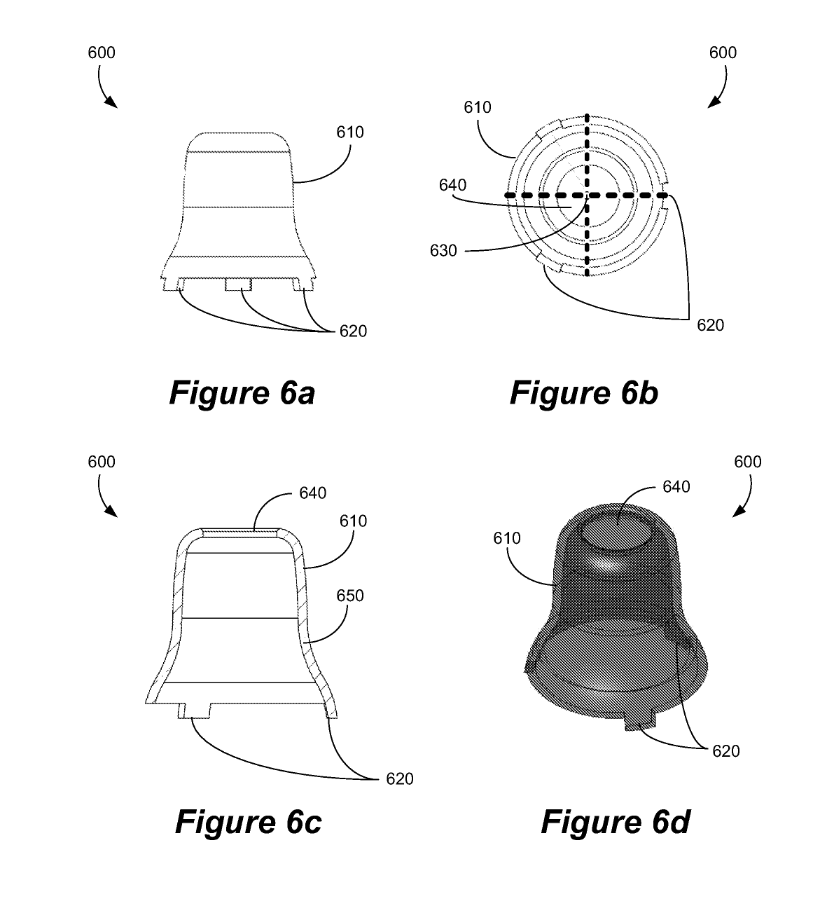

FIGS. 6a-d illustrate an exemplary cover element 600. FIG. 6a shows side view of cover element 600. Cover element 600 may have a top section 610 and connection elements 620. Connection elements 620 may be configured to affix to a support element and may cover and/or secure support element connection elements that affix a support element to a central support. Alternatively, connection elements may be configured to affix to a central support or any other element.

FIG. 6b shows a bottom view of cover element 600. Cover element 600 may have a hole 640 that may be centrally located in cover element 600 about center 630 and may be an opening slightly larger than the diameter of a central support. Hole 640 may allow for the insertion of a central support through cover element 600, allowing cover element to be configured above a support element affixed to a central support.

FIG. 6c is a cross-sectional view of cover element 600. Cover element 600 may have walls 650 that may be constructed of any material or combination of materials. Hole 640 may be oriented at the top of cover element 600 and allow a central support to pass through hole 640. Top section 610 and connection elements 620 may be constructed from a single piece of any type of material or combination of materials, or these sections may separate and affixed to one another. FIG. 6d illustrates a three-dimensional view of cover element 600.

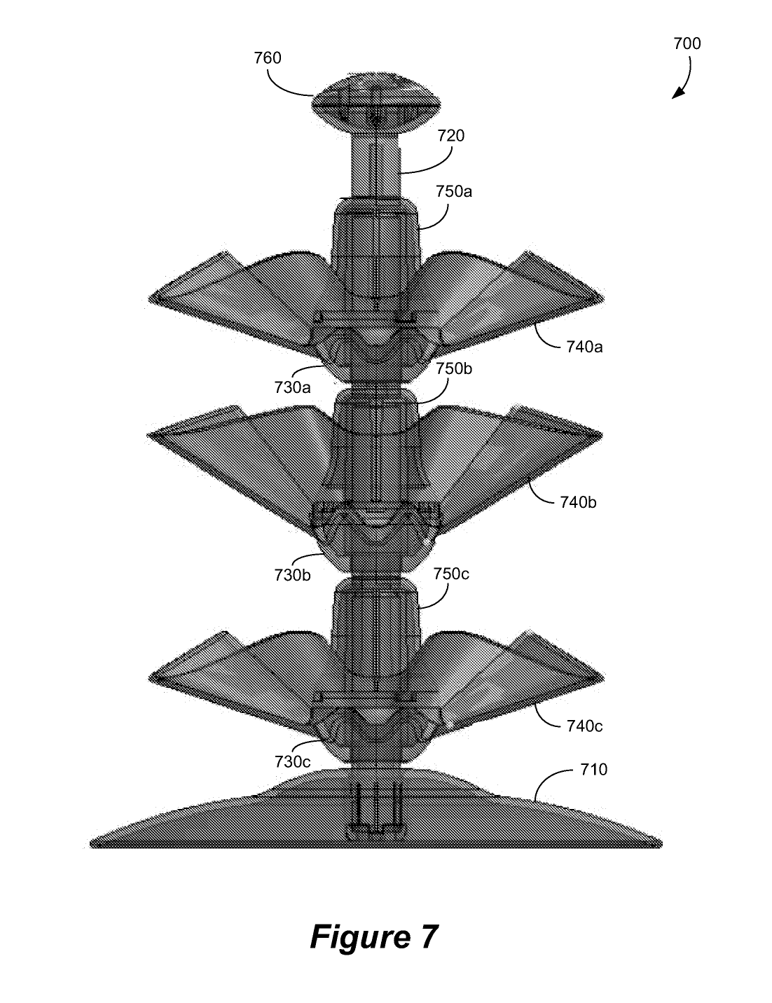

FIG. 7 illustrates a non-limiting exemplary embodiment of a display 700 constructed with the elements describe herein. Display 700 may have a base 710 into which central support 720 may inserted. Central support 720 may be fixedly attached to base 710, or movably attached, for example, so that central support 720 can rotate within a cavity in base 710. After central support 720 is affixed in base 710, hub 730c and support element 740c may be affixed to central support 720 and/or base 710 by inserting central support 720 through holes in hub 730c and support element 740c. In one embodiment, hub 730c and support element 740c are a single element.

Support element 740c may have connection elements that affix to a connection point on central support 720 as described herein. Once affixed to central support 720, support element 740c may be movable, for example, configured to be rotatable about central support 720, or may be stationary. Cover element 750c may next be affixed by inserting central support 720 through a hole in cover element 750c. Cover element 750c may cover support element 740c or a portion of support element 740c such as the connection elements of support element 740c. Cover element 750c may also assist in retaining support element 740c by preventing the actuation of connection elements of support element 740c, thus preventing the removal of support element 740c while cover element 750c is in place.

In another embodiment, only a single cover element, such as cover element 750a, may be used in a display. Such a cover element may be affixed at the top of the display, performing any of the cover element functions described herein. In such an embodiment, the functions performed by a cover element may also be performed by a hub element of a display. For example, hub 730b may perform the functions of cover element 750c, thus reducing the number of elements in a display. Alternatively, no cover element functionality may be required except for above the topmost support element of a display. By assisting in affixing the topmost element of a display, a cover element may function to secure all the elements in a display. In yet another alternative, no cover elements may be employed and all functions of a cover element may be performed by other elements, or not performed. All such embodiments are contemplated as within the scope of the present disclosure.

After cover element 750c is in place, additional elements, such as hub 730b, support element 740b, cover element 750b, hub 730a, support element 740a, and cover element 750a may be configured as shown in FIG. 7. Once all support elements are related elements are in place, then, in one embodiment, cap 760 may be affixed to central support 720. Note that cap 760 may be entirely optional and serve only cosmetic purposes in some embodiments, while in other embodiments, cap 760 may serve to retain other elements affixed to central support 720.

In an alternative embodiment, display 700 may be assembled roughly in the opposite manner as described above. For example, central support 720 may be constructed such that the topmost section of central support 720 may be larger than the holes through which central support 720 must be inserted to affix elements of display 700. This may be desirable for added security or stability. In such an embodiment, or if a user so desires, element may be constructed from the top of the display down.

For example, cover element 750a may be affixed to display 700 by inserting central support 720 through a hole in cover element 750a. Next, support element 740a may be affixed to display 700 by inserting central support 720 through a hole in support element 740a. Next, if hub element 730a is a separate element from support element 740a, hub element 730a may be affixed to display 700 by inserting central support 720 through a hole in hub element 730a. After hub element 730a is in place, additional elements, such as cover element 750b, support element 740b, hub 730b, cover element 750a, support element 740a, and hub 730a may be configured as shown in FIG. 7. Then central support 720, with elements attached, may be inserted into base 710. In such an embodiment, cap 760 may be affixed at any point.

The opening in a support element may be large enough to allow the support element to freely rotate about a central support. When multiple supports elements are installed on a display, such as display 700, each support element may be constructed to rotate individually and separately from other installed support elements. Support elements may include elements or means which enable or improve the ability of support elements to be stacked upon one another and rotate or otherwise move independently of other support elements. Alternatively, the support elements may be constructed such that the surfaces of each support element most proximate to other support elements interlock. When constructed in this way, all support elements will rotate in unison when one support element is made to rotate about a central support. Other means of arranging and constructing support elements may be recognized by those skilled in the art, and all such alternative arrangements and constructions are contemplated as within the scope of the present disclosure.

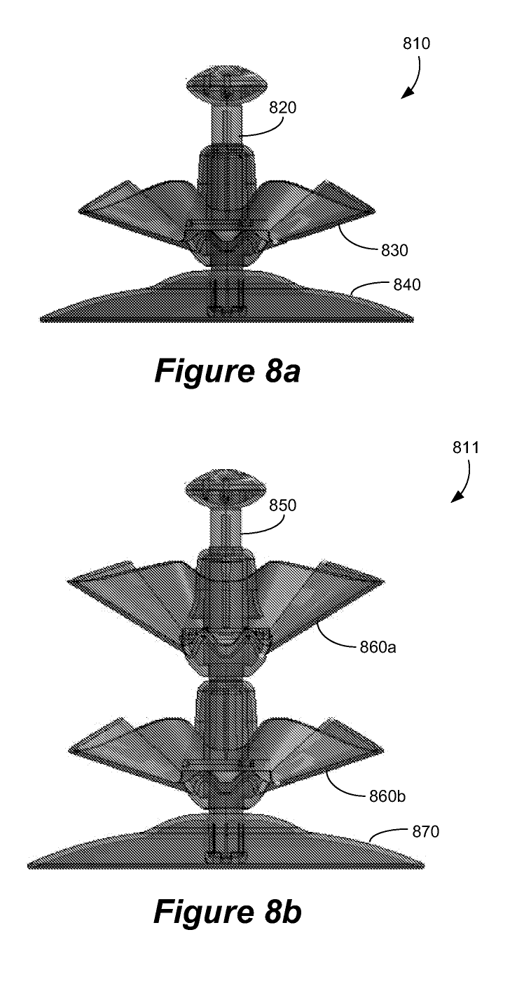

FIGS. 8a-b illustrate alternative embodiments enabled by the modular nature of the elements of the present disclosure. FIG. 8a shows a non-limiting, exemplary display 810 that may have a central support 820 that allows for a single support element 830 to be affixed. Central support 820 may be designed to support only a single support element. Alternatively, central support 820 may be one or more sections of a modular central support as described herein that allow for only a single support element to be affixed. Central support 820 may be affixed to base 840. Any of the other elements described herein, including hub and cover elements and caps, may be configured on display 810.

FIG. 8b shows a non-limiting, exemplary display 811 that may have a central support 850 that allows for two support elements 860a-b to be affixed. Central support 850 may be designed to support only two support elements. Alternatively, central support 850 may be one or more sections of a modular central support as described herein that allow for only two support elements to be affixed. Central support 850 may be affixed to base 870. Any of the other elements described herein, including hub and cover elements and caps, may be configured on display 811.

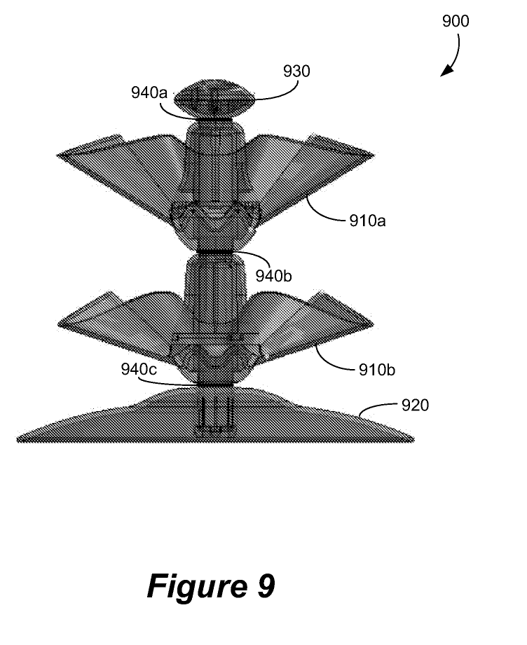

In another alternative embodiment, a central support is not used, and the support elements interconnect with one another to create a display with the needed structural support. In FIG. 9, such an embodiment is illustrated. Non-limiting, exemplary display 900 has a base 920 to which support element 910b directly affixes at attachment point 940c. Support element 910b may be constructed with a bottom section that is similar to a bottom section of a central support, or is may affix to base 920 using other means, including flexible elements configured to be inserted into notches in base 920. Support element 910a may then affix directly to support element 910b at attachment point 940b using any means, including flexible elements configured to be inserted into notches in support element 910b. Cap 930 may affix directly to support element 910a at attachment point 940a using any means. In such an embodiment, each element may be constructed to interconnect with any other element, or certain elements may have certain functions. For example, support element 910b may be specially designed to serve as a bottom support element that is capable of affixing to base 920, and/or support element 910a may be specially designed to serve as a top support element that is capable of affixing to cap 930. Other support element may be specially designed to be intermediate support elements, configured to be located between a top and bottom support elements.

In this embodiment, any of the elements described herein may be employed and any manner and method of constructions, number of support elements, materials or combination of materials may be used. All such embodiments are contemplated as within the scope of the present disclosure.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment but rather should be construed in breadth and scope in accordance with the appended claims.

What is claimed:

1. A display for supporting a cosmetic item, comprising:
a base;
a central support affixed to the base; and
at least one support element having a near end and a distal end, the near end affixed to the central support; and wherein the support element has a contour, wherein the contour of the support element separates the distal end into a plurality of compartments, each compartment configured to receive at least one cosmetic item thereon.

2. The display of claim 1, wherein the near end of the support element is rotatably affixed to the central support.

3. The display of claim 1, wherein the near end of the support element is nonmovably affixed to the central support.

4. The display of claim 1, wherein the near end of the support element comprises at least one connection element adapted to affix to an attachment point on the central support.

5. The display of claim 4, further comprising a cover element affixed about the near end of the support element and covering the at least one connection element.

6. The display of claim 5, wherein the cover element comprises first connection elements and the support element comprises second connection elements, and wherein the first connection elements are adapted to interconnect with the second connection elements.

7. The display of claim 4, wherein the attachment point is at least one notch on the central support, and wherein the at least one connection element comprises at least one flexible member adapted to mate to the at least one notch

8. The display of claim 1, further comprising a cap affixed to the topmost section of the central support.

9. The display of claim 1, wherein the central support is rotatably affixed to the base.

10. The display of claim 1, wherein the display is modular, wherein a first module of the display is the central support comprising first connection elements, a second module of the display is the base comprising second connection elements, and wherein the first connection elements are adapted to interconnect with the second connection elements.

11. The display of claim 1, wherein the central support is modular and comprises at least two detachably connected central support elements.

12. The display of claim 11, wherein each of the at least two connectable central support elements are adapted to support one support element.

13. The display of claim 11, wherein an attachment point is formed at a connection point where a first of the at least two connectable central support elements is connected to a second of the at least two connectable central support elements, and wherein the near end of the support element comprises at least one connection element adapted to affix to the attachment point.

14. The display of claim 1, wherein the support element is circular, wherein the near end of the support element comprises a hub, and wherein the hub is affixed to the central support.

15. A display for supporting a cosmetic item, comprising:
a base;
a central support affixed to the base, the central support configurable based on the size of the display and the items to be supported by the display; and
a first support element having two ends and affixed to the central support, the first support element comprising a connection means on one end and at least one supporting section on the opposite end; wherein the connecting means affixes the first support element to the central support, and wherein the first support element has a contour that separates the first support element into a plurality of compartments configured to receive the cosmetic item such that the cosmetic item is visible and accessible.

16. The display of claim 15, further comprising a second support element affixed to the central support.

17. The display of claim 15, wherein the first support element is constructed of translucent material, thereby enabling visual inspection of the cosmetic item through the first support element.

18. The display of claim 15, wherein the central support comprises first connection threads and the base comprises second connection threads, and wherein the central support is affixed to the base by interconnecting the first connection threads and second connection threads.

19. The display of claim 15, wherein the base comprises a first attachment point comprising at least one notch, wherein the central support comprises a second attachment point comprising at least one flexible member adapted to mate to the at least one notch.

20. The display of claim 15, wherein each of the plurality of compartments comprises a recessed cavity approximately the size of the cosmetic item.
